(19) United States
(12) Patent Application Publication
(10) Pub. No.: US 2018/0244000 A1
(43) Pub. Date: Aug. 30, 2018

(54) METHOD OF MAKING A FIBER-REINFORCED PLASTIC PART FOR WELDING TO A METAL PART

(71) Applicant: Rheinisch-Westfaelische-Technische Hochschule Aachen, Aachen (DE)

(72) Inventors: Marc ESSERS, Aachen (DE); Gregor George GINTROWSKI, Aachen (DE); Jens LOTTE, Aachen (DE); Uwe REISGEN, Eschweiler (DE); Alexander SCHIEBAHN, Langerwehe (DE)

(21) Appl. No.: 15/758,607

(22) PCT Filed: Aug. 30, 2016
(86) PCT No.: PCT/EP2016/001459

§ 371 Date: Mar. 8, 2018

(30) Foreign Application Priority Data
Oct. 19, 2015 (DE) 10 2015 013 402.7

(51) Int. Cl. B29C 70/86; B23K 11/14; B29C 70/88; B29C 70/68

(52) U.S. Cl. CPC B29C 70/86; B23K 11/14; B29C 66/7212; B29C 70/688; B29C 70/885

(57) ABSTRACT

The invention relates to a method for producing a component (1, 2) consisting of a fibre-reinforced plastic and prepared for the welding of a metal component (4), which comprises at least one fibre element (2) impregnated with a plastic matrix, wherein at least some portions of at least one metal joining partner (1) are integrated into a fibre element, a first section of the joining partner (1) being surrounded by the fibres of the fibre element (2) such that it is in contact therewith, and a second section of the joining partner (1) projecting over a surface of the fibre element (2) or lying at least in the surface, the joining partner (1) being connected, by at least some portions, to the liquid and hardening plastic matrix, especially at least by the first section. The invention also relates to a metal joining partner for integrating into a component consisting of fibre-reinforced plastic in order to weld a metal component (4) thereto.

The invention relates to a method of making a component of fiber-reinforced plastic for welding to a metal component and that has at least one fiber element embedded in a plastic matrix.

It is known in the prior art to use components of fiber-reinforced plastic in a great number of applications. These are normally fiber elements (for example glass fibers, carbon fibers, etc.) that are embedded in a plastic matrix (for example thermoplastic or thermosetting plastic, such as epoxy resin, for example) that are put into the desired component mold before embedding, thus forming the desired component after curing of the plastic matrix. The fiber elements are often weaves or laid meshes, particularly multiaxial meshes of the desired fiber types. Typical applications are in automobile body construction, for example, or generally where low weight with a high level of stability is required.

Despite the tendency in many areas to replace metallic components with components that are of fiber-reinforced plastic, it is often unavoidable to create joints between components of fiber-reinforced plastic and ordinary metal components. One area of application is the joining of a metallic door hinge to the car body of fiber-reinforced plastic.

Unlimited other applications are conceivable, and the invention described herein is not limited to this example.

Conventional ways of achieving this simply provide the finished, that is, the impregnated and hardened component of fiber-reinforced plastic afterward with holes, for example bores, for subsequently fastening of a connector element for the metal component to the component of fiber-reinforced plastic, for example by screws or rivets or even glue.

One problem with this is that the creation of holes on the finished component damages the fiber structure locally, resulting in local weakening, particularly in areas subjected to particularly high levels of stress.

It is therefore an object of the invention to provide a method and connector element suitable for same with which a component of fiber-reinforced plastic can be made in a simple manner for a highly stable connection of a metal component, particularly by means of a metallically integral connection, such as by welding, for example.

According to the invention, the object is achieved in that at least one metallic connector element is integrated into a fiber element at least in some areas, with a first part of the connector element being surrounded by the fibers of the fiber element and with a second part of the connector element projecting past an outer face of the fiber element or lying at least on the outer face and the connector element being joined at least in some areas with the liquid and hardening plastic matrix, particularly at least with the first part.

It is thus an essential idea of the invention for the metallic connector element to which a metal component can later be joined integrally, particularly by welding, to be an integral, particularly inseparable component of the finished fiber-reinforced component, which is achieved by positioning the connector element at least partially in or between the fibers of the fiber element (for example woven mat or interlaid mat) such that the fibers are engaged by the connector element. For example, the fibers can enclose or surround the connector element or at least areas thereof or guided through openings therein.

At the time of the integration of the connector element into a fiber element, the fibers thereof are thus still loose and/or the fiber element is still completely unimpregnated, or, if impregnated, the plastic matrix has at least not yet hardened.

The integration is preferably achieved in such a way that the fibers are not damaged, particularly not cut through or bent. Preferably, the connector elements can be embodied for this purpose such that, at most, they move out of their original position during the integration of fibers that have already been placed in the mold, particularly such that they nestle against areas of the connector element or, alternatively, the fibers of the fiber element are actively placed on the connector element, even placed through it, for example, for which purpose the connector element can also have holes.

A preferred embodiment of the method makes a provision that the connector element is integrated into the fiber element at least in some areas at a point in time at which the fiber element is still unimpregnated and the embedding and hardening is performed only thereafter.

By virtue of the method according to the invention, the connector element is also integrated cohesively into the component, namely by cohesion with the plastic matrix. A force acting on the connector element (for example after welding of a metal component) is thus transmitted directly to the plastic matrix and the fibers as well. In principle, the connector element integrated into and joined with the matrix also acts as a reinforcing element of the plastic matrix. The weakening produced in the prior art is thus avoided.

At least after the component has been completed, the connector element has a first part incorporated integrally into the component and a second part provided for the purpose of joining a metal component therewith by welding. For this purpose, this second part lies at least on the outer face of the fiber element or, more preferably, projects beyond same.

In one option, the invention can make a provision that the integrated connector element is completely surrounded by the plastic matrix by the embedding of the at least one fiber element. An area of the second part provided for the welding can be subsequently exposed from the plastic matrix after hardening of the latter, particularly by grinding.

However, the invention can also make a provision that the integration of the connector element into the component and the embedding occur in such a way that the area of the second part provided for welding or the entire second part is not engaged by the plastic matrix, at least not superficially from the side from which the metal component is to be secured. As a result, subsequent processing can be omitted.

In one embodiment, a provision can be made that the connector element is formed by a planar element having holes, in which case unimpregnated fibers particularly extend through the holes of the connector element. Such a planar element with holes can be formed by a metal mesh, lattice, or woven fabric with corresponding mesh, for example.

Especially in the case of a metal woven fabric, at the crossings woven wires that pass over one another can be arranged on the sides of the connector element turned toward the fiber element between particularly unimpregnated fibers. To achieve this, the metal woven fabric need only for example be pressed onto the outer face of the fiber element.

In one embodiment a particularly unimpregnated fiber element is surrounded on both sides by two connector elements and the two connector elements engage each other through the thickness of the fiber element. They can for example contact one another through areas that project respectively from one connector element toward the other, are oppositely situated, and touch each other through the thickness of the fiber element. A connection can be established by resistance welding, for example, particularly by a current conducted through touching parts. If a wire mesh is used as the two connector elements, then the projecting areas that touch one another can be formed by the woven wires where they cross. The connection is created before embedding in all cases here.

According to another preferred embodiment of the invention the connector element can be formed by a planar metal element, particularly a metal plate having pin-shaped anchor elements, particularly each with a head on an outer end projecting from the outer face on at least one side, and at least the anchor elements form a first part of the connector element and are integrated into the fiber element, particularly by insertion of the anchor elements into the fiber element in the direction of thickness.

In one simple case, the planar part of the connector element can be placed on the outer face of the fiber element and form the second part on which welding can be subsequently performed, in which case the anchor elements that are preferably only on one side are inserted between the fibers in the direction of thickness of the fiber element, especially preferably perpendicular to the outer face thereof, with the free anchor ends lying particularly within the thickness of the fiber element.

The connector element is held in the fiber element by virtue of the heads that are preferably provided since the heads are able to act as an undercut.

Insofar as the free anchor ends reach through the thickness of the fiber element and project above the outer face on the other side thereof, or at end therein, these heads can also act as the second part with which a metal component can be joined by welding, preferably by resistance projection welding in this case. In such a case, the ends of the anchor elements, particularly the heads thereof toward the outside, that is, toward the future metal component, are preferably spherical or at least tapering so that these ends can act as welding projections.

In another embodiment that the planar part of the connector element can be integrated into the fiber element and is particularly surrounded in a contacting manner on both sides by fibers, preferably centered with respect to the thickness of the fiber element, and the anchor elements extend in the direction of thickness from the planar part toward the outer face of the fiber element and end in or past the outer face, and the free anchor element ends form the second part. Such an embodiment can be used especially preferably in conjunction with fiber meshes or positioned between two fiber weaves.

With a connector element of the above-described type, the preferably pin-shaped anchor elements can be elements that were originally separate and attached to a plate, for example even by welding. However, that the anchor elements can be formed by regions formed on the outer face of the connector element and that are defined by punching or cutting and are bent out of the outer face plane.

Preferred embodiments of the invention are described below.

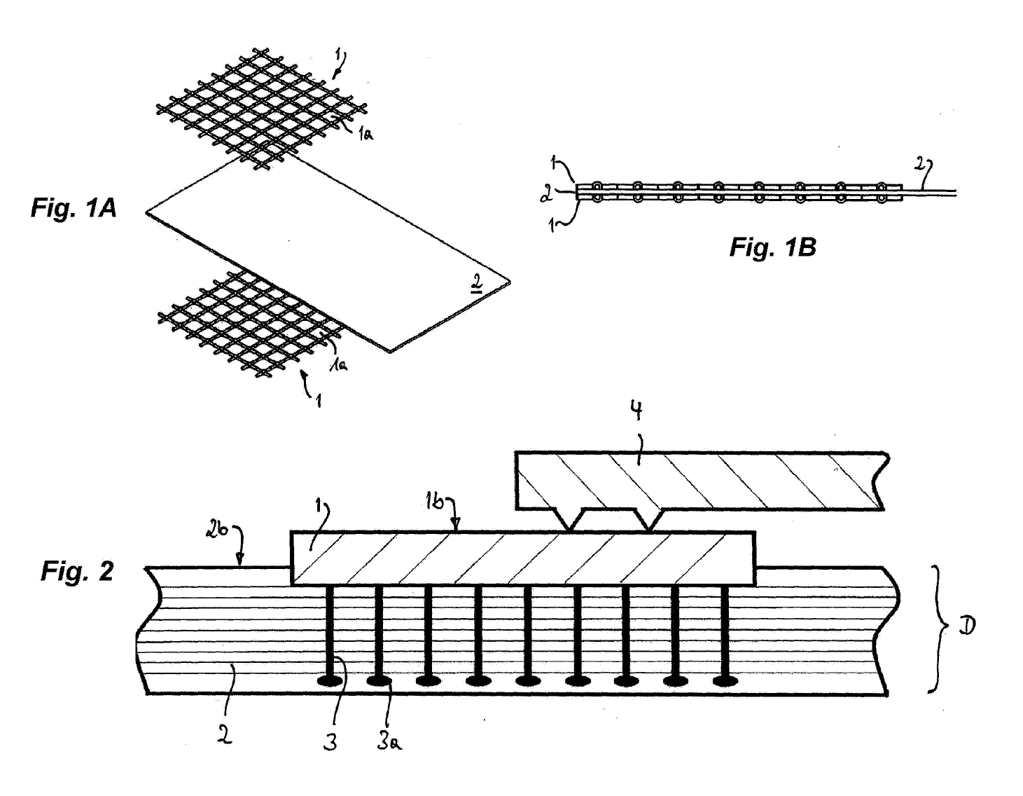

FIG. 1 shows a first embodiment of the invention in which the connector element for a metal component to be welded (not shown) is formed by a lattice-like wire mesh 1 with mesh holes 1a. In the present case, a fiber element 2, for example a laid mesh or also woven fabric of reinforcing fibers (for example glass fibers, carbon fibers) is engaged on each side by a respective wire mesh 1. At the points of intersection of the wires, the wire mesh has a wire that passes over and a wire that passes under. By the placement, preferably pressing of the respective wire mesh 1 onto the fiber element 2, at least the wires that are passing over and turned toward the fiber element penetrate into the fiber element in the crossing areas, since these are the ones that project farthest toward the fiber element. The wire mesh is thus engaged by a plurality of fibers of the fiber element 2. However, to guide the fibers through the mesh holes 1a, particularly if the fiber element 2 is a laid fleece, in which case the fibers can be woven with the wire mesh through its mesh openings.

Here, the wire meshes 1 can contact each other through the fiber element at the wires that pass over and facing one another, for example. The possibility thus exists of interconnecting the wire meshes, for example with resistance welding. The fibers themselves can also bond to the wires, for example by integration (for example solid-state welding) or by fusing of the fibers or of a coating surrounding them in order to achieve adhesion, and/or the fibers are clamped between the wires by a frictional connection. The wire meshes 1 thus already form an integral part that can no longer be separated from the fibers, so that forces exerted on the wire meshes 1 are transmitted to the fibers.

After the joining of the wire meshes 1 to one another and preferably to the fibers of the fiber element 2 as well, the embedding with the plastic matrix, for example epoxy resin, can be performed, which also bonds to the wire meshes. After that, they form an integral part of the finished fiber-reinforced plastic component and can act as connector elements to which a metal component can be welded, preferably via welding projections, since the wires of the wire mesh 1 that pass over and project away from the fiber element 2 can be utilized as welding points. In terms of the general description of the invention, the wires that pass over and point toward the fiber element thus form the first part of the connector element integrated into the component, and the wires that pass over and face toward the later metal component form the second part, to which the metal component can be welded.

FIG. 2 shows an alternative embodiment where the connector element is a metal plate 1 that has a plurality of pin-shaped anchor elements 3 on its face turned toward the fiber element 2. These anchor elements 3 have a length that is less than a thickness D of the fiber element 2 and have larger-diameter heads 3a that do not extend completely through the fiber element 2 in the direction of thickness, i.e. they are partially embedded in the fiber element 2. The metal plate 1 is secured to the fiber element 2 at these heads alone. The metal plate 1 can be inserted into the fiber element before or also after embedding with but before hardening of the matrix material, particularly such that its outer face 1b, which is the upper outer face here, lies above the outer face 2b of the fiber element and is not covered by the matrix material. This face 1b can thus be used as a “welding island” in the composite component in order to join a metal component 4 therewith, for example by one-sided resistance (projection) welding, laser beam welding, or other welding methods. When resistance projection welding is used, natural, pronounced, or massive projections can be considered for use as welding projections.

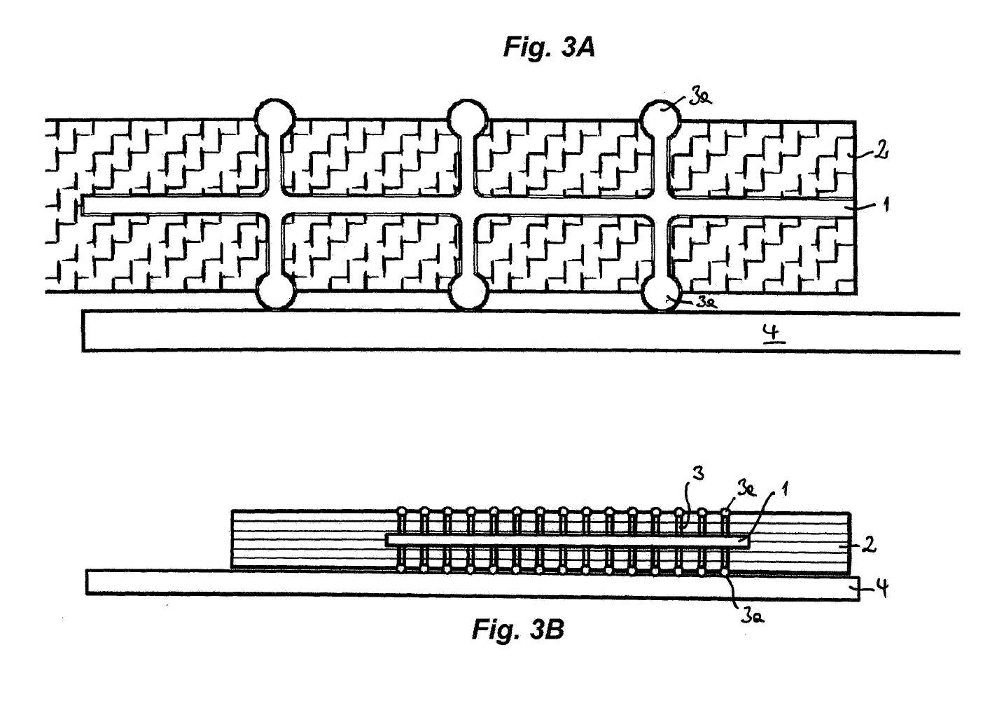

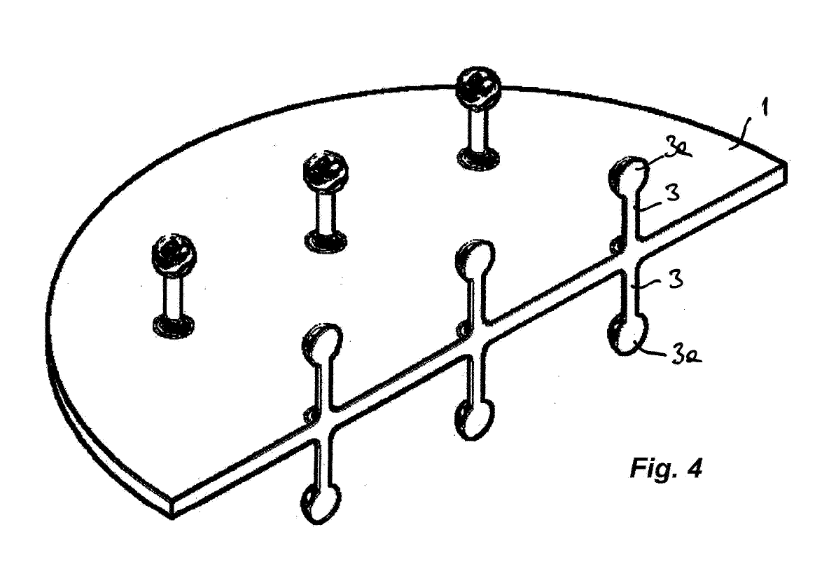

FIG. 3 and FIG. 4 show an additional embodiment where the connector element is a metal plate 1 that has pin-shaped anchor elements 3 with heads 3a on both sides. In this embodiment, both the metal plate 1 and the pin regions of the anchor elements 3 and, in part, the heads 3a thereof are to be regarded as the first part, that comes to be an integral part of the component. Here, the plate 1 is preferably arranged centrally in a fiber element 2 that can be formed for example by two fiber weaves that have been pressed over the anchor elements 3 on both sides of the plate.

The anchor elements 3 have a length that is such that the heads thereof project at least partially out of the face of the fiber element. The connector element can in turn be integrated into the component by embedding with matrix material. The bilateral projecting heads can act as projections for resistance welding.

After this, a metal component 4 can be welded at any time without any difficulty, for example using resistance projections, to the outwardly facing spherical heads, particularly on both sides.

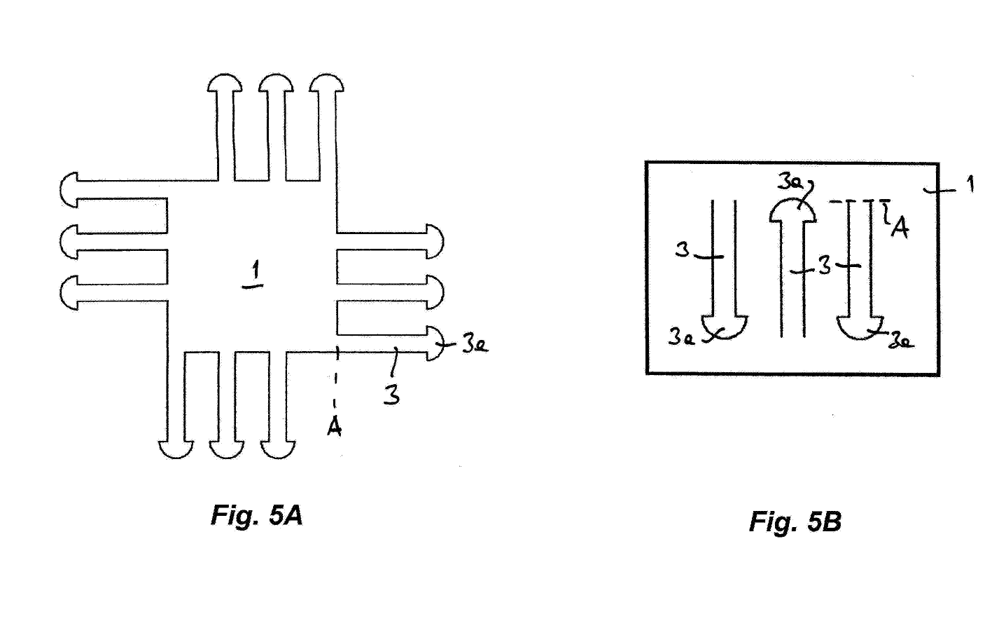

FIG. 5 shows a connector element in the form of a plate 1 in which the shape of each anchor element 3 along with its head 3 is made by punching or cutting, for example laser cutting. By bending the contoured anchor elements 3 about an axis A that lies on the plane, the anchor elements can be embodied so as to project from the plate outer face, thus enabling the plate 1 to be inserted therewith into a fiber element.

1. A method of making a component of fiber-reinforced plastic for welding to a metal component and that has at least one fiber element embedded in a plastic matrix, the method comprising the steps of:
integrating at least one metallic connector element having first and second parts into the fiber element at least in some areas with the first part of the connector element surrounded by fibers of the fiber element and the second part of the connector element projecting past a face of the fiber element or lying at least on the face and
joining the connector element at least at the first part with the liquid and hardening plastic matrix.

2. The method defined in claim 1, further comprising the step, during the embedding of the at least one fiber element of:
surrounding the integrated connector element completely by the plastic matrix; and
subsequently exposing an area of the second part provided for the welding the plastic matrix after hardening of the latter.

3. The method defined in claim 1, wherein the connector element is a planar metal mesh, screen, or weave having openings through which extend unimpregnated fibers or into which project crossing woven wires on the sides of the connector element turned toward the fiber element between particularly unimpregnated fibers.

4. The method defined in claim 1, further comprising the steps of:
surrounding the fiber element on both sides by two of the connector elements;
engaging the two connector elements with each other through the thickness of the fiber element crossings of woven wires; and
joining the connector elements through the fiber element by resistance welding.

5. The method defined in claim 1, wherein the connector element is formed by a planar metal plate having pin-shaped anchor elements each in turn having a head on an outer end and projecting from the face on at least one side of the component, the method further comprising the step of:
integrating at least the anchor elements forming the first part of the connector element and into the fiber element by insertion of the anchor elements in the direction of thickness into the fiber element.

6. The method defined in claim 5, wherein a planar region of the connector element is integrated into the fiber element and is surrounded in a contacting manner on both sides by fibers, and the anchor elements extend in the direction of thickness from the planar part in the direction toward an outer face of the fiber element and end in or past the outer face, and the free anchor element ends form the second part.

7. The method defined in claim 5, wherein the planar part of the connector element is placed on an outer face of the fiber element and forms the second part, with the anchor elements inserted between fibers in the direction of thickness of the fiber element, and free anchor ends lying particularly within the thickness of the fiber element.

8. A metallic connector element for integration into a component of fiber-reinforced plastic for the purpose of the welding of a metal component, thereto, the connector element comprising:
a planar metal plate having pin-shaped anchor elements each with an enlarged head on an outer end and projecting from the outer face on at least one side, the anchor elements forming a first part of the connector element that can be integrated into the fiber element by insertion of the anchor elements into the fiber element in the direction of thickness.
